(19) United States
(12) Patent Application Publication
(10) Pub. No.: US 2017/0239913 A1
(43) Pub. Date: Aug. 24, 2017

(54) LIGHTWEIGHT COMPOSITE MATERIAL AND METHOD FOR MAKING THE SAME

(71) Applicant: Advanced International Multitech Co., Ltd., Kaohsiung City (TW)

(72) Inventor: Chang-Hung TSAI, Kaohsiung City (TW)

(73) Assignee: Advanced International Multitech Co., Ltd., Kaohsiung City (TW)

(21) Appl. No.: 15/164,031

(22) Filed: May 25, 2016

(30) Foreign Application Priority Data
Feb. 23, 2016 (TW) 105105210

(51) Int. Cl. B32B 5/26; B29C 65/48; B32B 37/06; B29C 65/02; B32B 27/12; B32B 27/20

(52) U.S. Cl. CPC B32B 5/26; B32B 27/12; B32B 27/20; B32B 37/06; B29C 65/02; B29C 65/4835; B32B 2262/101; B32B 2262/106; B32B 2264/101; B32B 2398/10; B32B 2307/718; B32B 2307/72; B29K 2101/10

(57) ABSTRACT

A lightweight composite material includes a substrate and a carbon fiber layer. The substrate has a first surface and a second surface opposite to each other, and is prepared by impregnating glass fibers with a resinous matrix which is formed by mixing hollow glass microspheres with a thermosettable resin material. The carbon fiber layer is bonded to one of the first and second surfaces of the substrate by thermosetting the thermosettable resin material.

### CROSS-REFERENCE TO RELATED APPLICATION

This application claims priority of Taiwanese Patent Application No. 105105210, filed on Feb. 23, 2016.

### FIELD

The disclosure relates to a composite material, and more particularly to a composite material that is lightweight. The disclosure also relates to a method for making the composite material.

### BACKGROUND

Carbon fibers are mainly used for making various shell bodies because of superior performances thereof in mechanical strength, hardness, corrosion resistance, and the like, and are commonly used in product fields such as bicycle frames, laptop computers, and golf club heads. However, carbon fibers have a density generally ranging from about 1.5 g/cm³ to about 2 g/cm³, which is undesirably high for carbon-fiber-containing products which require lightness in weight. Therefore, it is needed in the market to develop a carbon-fiber-containing composite material which may meet the lightweight requirement in the art.

Referring to FIG. 1, a conventional composite material 1 for a shell body includes a core layer 11 which is made from a foam material and which is in a honeycomb form, and two carbon fiber layers 12 sandwiching the core layer 11. The composite material 1 has a density 1.15 g/cm³, which is relatively low as compared to the general density of carbon fibers mentioned above. The composite material 1 is made by oppositely disposing two carbon fiber prepreg sheets on the core layer 11 to prepare a laminate and then thermo-pressing the laminate such that a thermosettable resin contained in the carbon fiber prepreg sheets is heat set to form the two carbon fiber layers 12 sandwiching and bonded to the core layer 11.

However, since the core layer 11 is in the form of a honeycomb foam with pores therein, it is difficult to get a sufficient amount of the thermosettable resin to be filled in the pores in the core layer 11 during the thermo-pressing for forming the carbon fiber layers 12. When the filled amount is insufficient, the bonding strength between the core layer 11 and the carbon fiber layers 12 will be greatly affected. In addition, the quality of the composite material 1 thus made is uncontrollable and thus inferior.

Therefore, it is desirable in the art to develop a composite material having a much lower density, a superior bonding strength, and a stable product quality.

### SUMMARY

An object of the disclosure is to provide a lightweight composite material which has a low density and a superior bonding strength.

Another object of the disclosure is to provide a method for making the lightweight composite material.

According to a first aspect of the disclosure, there is provided a lightweight composite material including a substrate and a carbon fiber layer. The substrate has a first surface and a second surface opposite to each other, and is prepared by impregnating glass fibers with a resinous matrix which is formed by mixing hollow glass microspheres with a thermosettable resin material. The carbon fiber layer is bonded to one of the first and second surfaces of the substrate by thermosetting the thermosettable resin material.

According to a second aspect of the disclosure, there is provided a method for making a composite material which includes the steps of:

(a) applying on two opposite surfaces of a glass fiber fabric a resinous matrix, which is formed by mixing hollow glass microspheres with a thermosettable resin material, to prepare a resinous-matrix-applied glass fiber fabric;

(b) sandwiching the resinous-matrix-applied glass fiber fabric with a first carbon fiber prepreg sheet and a second carbon fiber prepreg sheet to prepare a laminate; and

(c) thermo-pressing the laminate.

According to the disclosure, the resinous-matrix-applied glass fiber fabric and the carbon fiber prepreg sheet are firmly bonded to each other after thermo-pressing. In addition, there is no pores in the resinous-matrix-applied glass fiber fabric prepared by applying on two opposite surfaces of the glass fiber fabric the resinous matrix which is formed by mixing the hollow glass microspheres with the thermosettable resin material, the problem of inferior product quality encountered in the aforesaid prior art due to use of the core layer 11 made from a foam material can be avoided.

Furthermore, since the hollow glass microspheres have a relatively low density and since the carbon fibers and the glass fibers have high mechanical strength, the composite material of the disclosure is lightweight and yet of high mechanical strength.

### BRIEF DESCRIPTION OF THE DRAWINGS

Other features and advantages of the disclosure will become apparent in the following detailed description of the embodiment (s) with reference to the accompanying drawings, of which:

FIG. 1 is a schematic sectional view of a conventional composite material for a shell body;

FIG. 2 is a schematic sectional view of a first embodiment of a lightweight composite material according to the disclosure;

FIG. 3 is a flow diagram of a method for making the first embodiment;

FIG. 4 is a schematic diagram showing consecutive steps of the method for making the first embodiment;

FIG. 5 is a schematic sectional view of a second embodiment of a lightweight composite material according to the disclosure;

FIG. 6 is a schematic diagram showing consecutive steps of the method for making the second embodiment; and

FIG. 7 is a schematic sectional view of a third embodiment of a lightweight composite material according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

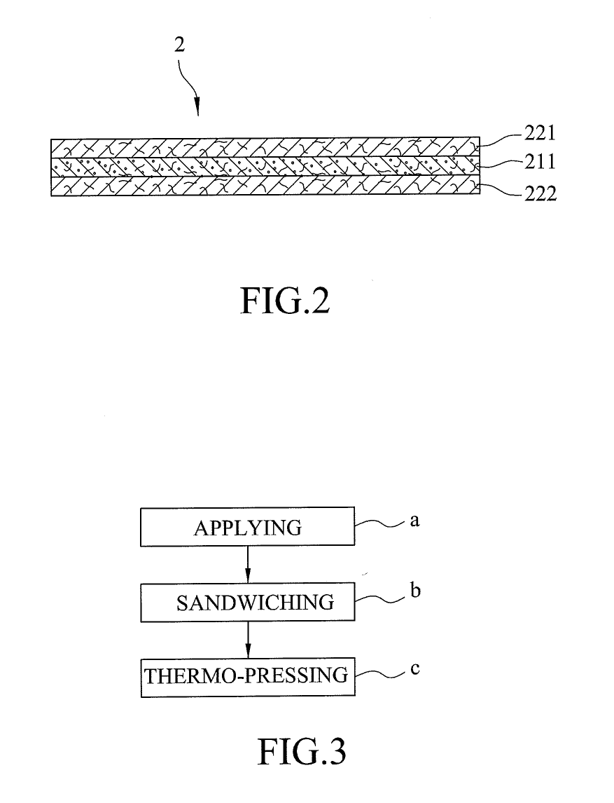

Referring to FIG. 2, the first embodiment of a lightweight composite material 2 according to the disclosure includes a first substrate 211, a first carbon fiber layer 221, and a second carbon fiber layer 222.

The first substrate 211 has a first surface and a second surface opposite to each other, and is prepared by impregnating glass fibers with a resinous matrix which is formed by mixing hollow glass microspheres with a thermosettable resin material. Each of the hollow glass microspheres have a density ranging from 0.2 g/cm³ to 0.6 g/cm³.

The first carbon fiber layer 221 is bonded to one of the first and second surfaces of the first substrate 211 by thermosetting the thermosettable resin material.

The second carbon fiber layer 222 is disposed on the other one of the first and second surfaces of the first substrate 211. In the embodiment, the second carbon fiber layer 222 is bonded to the other one of the first and second surfaces of the first substrate 211 by thermosetting the thermosettable resin material.

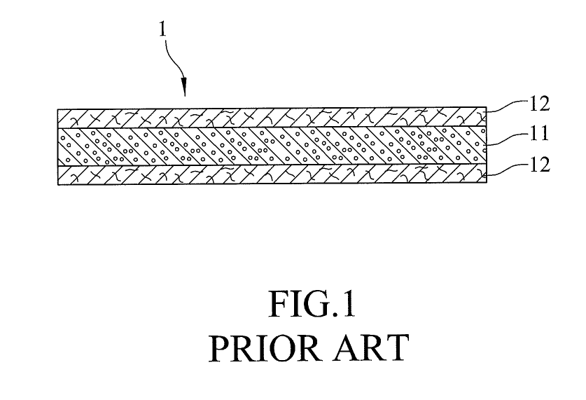

Since the carbon fibers used in the first and second carbon fiber layers 221, 222 have high mechanical strength and the hollow glass microspheres used in the first substrate 211 have a low density, the lightweight composite material 2 made is lightweight and yet of high mechanical strength. The density of the lightweight composite material 2 has a density ranging from 0.6 g/cm³ to 0.8/cm³, which is lower than that of the prior art shown in FIG. 1.

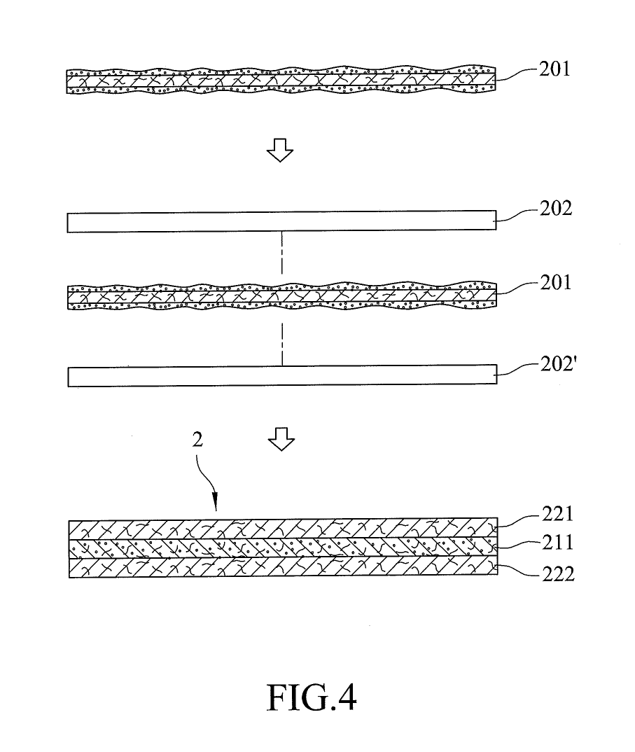

Referring to FIGS. 3 and 4, a method for making the first embodiment of the lightweight composite material 2 according to the disclosure includes the steps of:

(a) applying on two opposite surfaces of a glass fiber fabric a resinous matrix, which is formed by mixing hollow glass microspheres with a thermosettable resin material, to prepare a first resinous-matrix-applied glass fiber fabric 201;

(b) sandwiching the first resinous-matrix-applied glass fiber fabric 201 with a first carbon fiber prepreg sheet 202 and a second carbon fiber prepreg sheet 202′ to prepare a laminate; and

(c) thermo-pressing the laminate to form the lightweight composite material 2.

The first resinous-matrix-applied glass fiber fabric 201 and the first and second carbon fiber prepreg sheets 202, 203′ in the laminate are bonded together by thermo-pressing the laminate so as to thermoset the thermosettable resin material, such that the lightweight composite material 2 is made in which the first substrate 211 is made from the first resinous-matrix-applied glass fiber fabric 201 and the first and second carbon fiber layers 221, 222 are respectively made from the first and second carbon fiber prepreg sheets 202, 202′.

Since there are no pores in the first resinous-matrix-applied glass fiber fabric 201, the lightweight composite material 2 thus made does not have the problem of inferior product quality encountered in the prior art shown in FIG. 1.

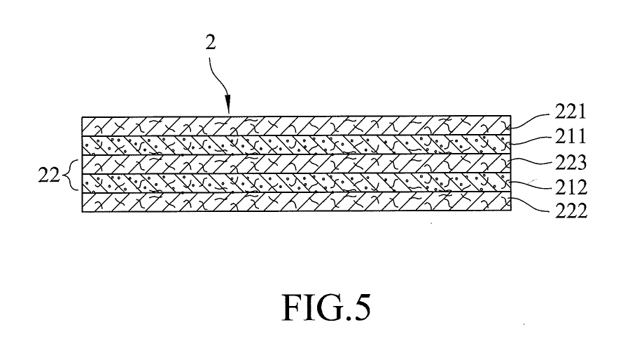

Referring to FIG. 5, the second embodiment of a lightweight composite material 2 according to the disclosure is substantially similar to the first embodiment except that a bi-layer sheet 22 is further included and is sandwiched between the first substrate 211 and the second carbon fiber layer 222. The bi-layer sheet 22 includes a second substrate 212 and a third carbon fiber layer 223. The second substrate 212 is prepared by impregnating the glass fibers with the resinous matrix which is formed by mixing the hollow glass microspheres with the thermosettable resin material. The third carbon fiber layer 223 is bonded to the second substrate 212 by thermosetting the thermosettable resin material.

It should be noted that more than one of the bi-layer sheets 22 may be sandwiched between the first substrate 211 and the second carbon fiber layer 222.

In the second embodiment, each of the first and second substrates 211, 212 is sandwiched between two sequential ones of the first, second, and third carbon fiber layers 221, 222, 223. In other words, the first substrate 211 is sandwiched between the first carbon fiber layer 221 and the third carbon fiber layer 223, the third carbon fiber layer 223 is sandwiched between the first substrate 211 and the second substrate 212, and the second substrate 212 is sandwiched between the third carbon fiber layer 223 and the second carbon fiber layer 222.

Likewise, the density of the second embodiment of the lightweight composite material 2 has a density ranging from 0.6 g/cm³ to 0.8/cm³, which is lower than that of the prior art shown in FIG. 1.

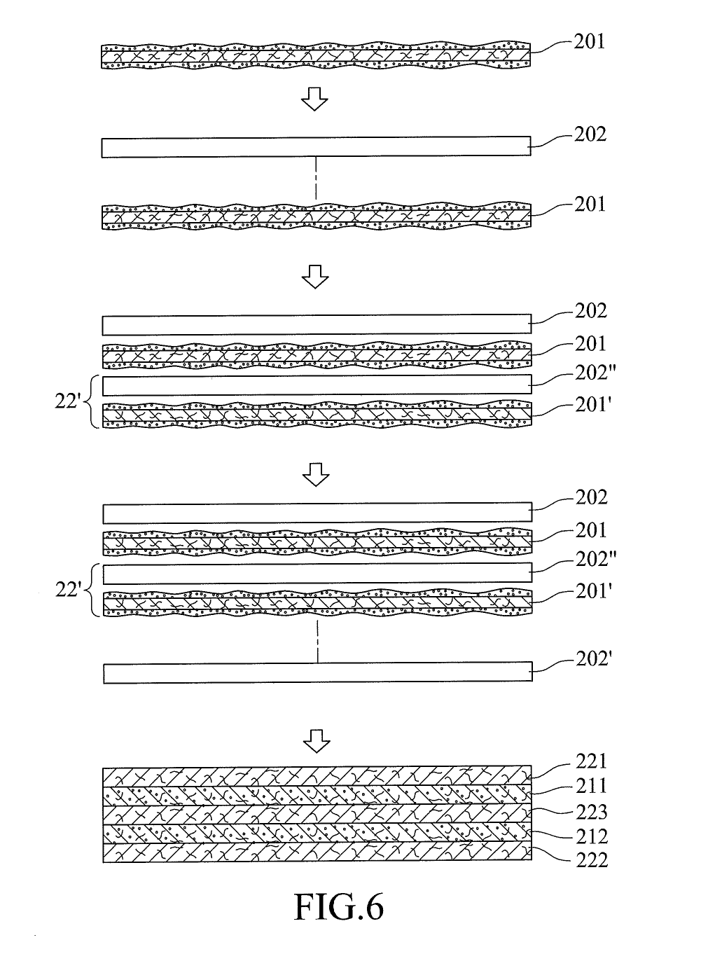

Referring to FIG. 6, a method for making the second embodiment of the lightweight composite material 2 according to the disclosure is substantially similar to the method for making the first embodiment of the lightweight composite material 2 according to the disclosure except that the method for making the second embodiment of the lightweight composite material 2 according to the disclosure further includes, prior to step (c), the steps of:

(b1) applying on a second glass fiber fabric the resinous matrix which is formed by mixing the hollow glass microspheres with the thermosettable resin material to prepare a second resinous-matrix-applied glass fiber fabric 201′;

(b2) laying a third carbon fiber prepreg sheet 202″ on the resinous matrix of the second resinous-matrix-applied glass fiber fabric 201′ to prepare a bi-layer structure 22′; and

(b3) disposing the bi-layer structure 22′ between the second carbon fiber prepreg sheet 202′ and the first resinous-matrix-applied glass fiber fabric 201 to form the laminate.

It should be noted that the aforesaid steps (b1)-(b3) may be repeated to form more than one of the bi-layer structures 22′ between the second carbon fiber prepreg sheet 202′ and the first resinous-matrix-applied glass fiber fabric 201.

In the second embodiment of the lightweight composite material 2, the first and second substrates 211, 212 are respectively made from the first and second resinous-matrix-applied glass fiber fabrics 201, 201′ and the first, second, and third carbon fiber layers 221, 222, 223 are respectively made from the first, second, and third carbon fiber prepreg sheets 202, 202′, 202″.

Likewise, since there are no pores in the first and second resinous-matrix-applied glass fiber fabrics 201, 201′, the lightweight composite material 2 thus made does not have the problem of inferior product quality encountered in the prior art shown in FIG. 1.

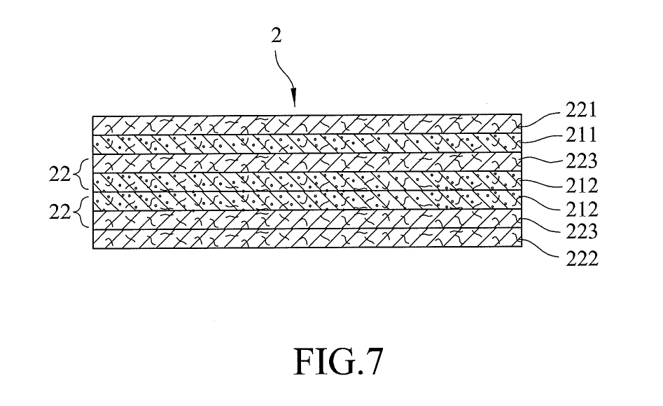

Referring to FIG. 7, the third embodiment of a lightweight composite material 2 according to the disclosure is substantially similar to the second embodiment except that two of the bi-layer sheets 22 are included and are sandwiched between the first substrate 211 and the second carbon fiber layer 222, and that the second substrate 212 of one of the two bi-layer sheets 22 is contiguous to the second substrate 212 of the other one of the two bi-layer sheets 22.

It is thus should be noted that when two or more of the bi-layer sheets 22 are sandwiched between the first substrate 211 and the second carbon fiber layer 222, it is not necessary to dispose the third carbon fiber layers 223 and the second substrates 212 of the bi-layer sheets 22 alternately.

In view of the aforesaid, since the carbon fibers used in the carbon fiber layer(s) have high mechanical strength and the hollow glass microspheres used in the substrate(s) have a low density, the lightweight composite material according to this disclosure is lightweight and yet of high mechanical strength.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A lightweight composite material comprising:
a first substrate having a first surface and a second surface opposite to each other, and being prepared by impregnating glass fibers with a resinous matrix which is formed by mixing hollow glass microspheres with a thermosettable resin material; and
a first carbon fiber layer bonded to one of said first and second surfaces of said first substrate by thermosetting said thermosettable resin material.

2. The lightweight composite material according to claim 1, further comprising a second carbon fiber layer disposed on the other one of said first and second surfaces of said first substrate.

3. The lightweight composite material according to claim 2, wherein said second carbon fiber layer is bonded to said first substrate by thermosetting said thermosettable resin material.

4. The lightweight composite material according to claim 2, further comprising a bi-layer sheet sandwiched between said first substrate and said second carbon fiber layer, said bi-layer sheet including:
a second substrate prepared by impregnating said glass fibers with said resinous matrix which is formed by mixing said hollow glass microspheres with said thermosettable resin material; and
a third carbon fiber layer bonded to said second substrate by thermosetting said thermosettable resin material.

5. The lightweight composite material according to claim 4, wherein each of said first and second substrates is sandwiched between two proximate ones of said first, second, and third carbon fiber layers.

6. The lightweight composite material according to claim 1, each of said hollow glass microspheres has a density ranging from 0.2 g/cm³ to 0.6 g/cm³.

7. A method for making a lightweight composite material comprising the steps of:
(a) applying on two opposite surfaces of a glass fiber fabric a resinous matrix, which is formed by mixing hollow glass microspheres with a thermosettable resin material, to prepare a first resinous-matrix-applied glass fiber fabric;
(b) sandwiching the first resinous-matrix-applied glass fiber fabric with a first carbon fiber prepreg sheet and a second carbon fiber prepreg sheet to prepare a laminate; and
(c) thermo-pressing the laminate.

8. The method according to claim 7, further comprising, prior step (c), the steps of:
(b1) applying on a second glass fiber fabric the resinous matrix which is formed by mixing the hollow glass microspheres with the thermosettable resin material to prepare a second resinous-matrix-applied glass fiber fabric;
(b2) laying a third carbon fiber prepreg sheet on the resinous matrix of the second resinous-matrix-applied glass fiber fabric to prepare a bi-layer structure; and
(b3) disposing the bi-layer structure between one of the first and second carbon fiber prepreg sheets and the first resinous-matrix-applied glass fiber fabric to form the laminate.
